(19) United States
(12) Patent Application Publication
(10) Pub. No.: US 2024/0339587 A1
(43) Pub. Date: Oct. 10, 2024

(54) SECONDARY BATTERY CELL

(71) Applicant: SK On Co., Ltd., Seoul (KR)

(72) Inventor: Jae Sik SHIN, Daejeon (KR)

(21) Appl. No.: 18/623,039

(22) Filed: Apr. 1, 2024

(30) Foreign Application Priority Data
Apr. 4, 2023 (KR) 10-2023-0043981

(51) Int. Cl. H01M 4/13; H01M 50/531

(52) U.S. Cl. CPC H01M 4/13; H01M 50/531

(57) ABSTRACT

Provided is a secondary battery cell comprising: a casing; and an electrode assembly accommodated in the casing and having electrode plates stacked with a separator interposed therebetween, wherein the electrode plate and the separator are adhered to each other by a coating layer, the electrode plate includes an electrode uncoated portion on which an active material is not applied to a portion of the electrode plate, and an electrode current collector to which an active material is applied, and the coating layer includes a first coating layer formed on the electrode uncoated portion.

### CROSS-REFERENCE TO RELATED APPLICATION(S)

This patent document claims the priority and benefits of Korean Patent Application No. 10-2023-0043981 filed on Apr. 4, 2023, the disclosure of which is incorporated herein by reference in its entirety.

### TECHNICAL FIELD

The disclosure and implementations disclosed in this patent document generally relate to a secondary battery cell.

### BACKGROUND

Generally, unlike primary batteries, secondary batteries may be charged and discharged and may thus be applied to devices within various fields such as a digital camera, a mobile phone, a laptop computer, a hybrid vehicle, and an electric vehicle.

Such secondary batteries may be divided into a nickel-cadmium battery, a nickel-hydrogen battery, and a lithium-ion battery, depending on what material is used for a cathode, an anode, or an electrolyte, and may be morphologically classified into a cylindrical type, a prismatic type, or a pouch type.

Recently, in terms of battery shape, there has been high demand for prismatic batteries and pouch-type batteries that may be applied to products such as mobile phones due to a reduced thickness thereof, and in terms of materials, there is high demand for lithium secondary batteries such as lithium cobalt polymer batteries with high energy density, discharge voltage, and stability.

In general, lithium secondary batteries generally include an electrode assembly with a cathode, separator, and cathode structure and an electrolyte solution, and are classified into a lithium-ion battery, a lithium polymer battery, etc., depending on the composition of the electrolyte.

The lithium secondary battery is largely divided into a jelly-roll type and a stack type depending on the structure of the electrode assembly. For example, the jelly-roll type electrode assembly is suitable for a cylindrical battery, but when the jelly-roll type electrode assembly is applied to prismatic or pouch-type batteries, the jelly-roll type electrode assembly has disadvantages such as problems with delamination of electrode active materials and low space utilization. Additionally, there is a problem in that high stress is applied to a bent portion, causing deformation of the electrode.

Meanwhile, the stack-type electrode assembly is a structure in which a plate-shaped current collector is cut to a desired size to manufacture a plurality of cathode and anode units and then the plurality of cathode and anode units are sequentially stacked. The stack-type electrode assembly has the advantage of being easy to use to obtain a prismatic shape, and there is no problem of an occurrence of deformation of the electrode due to stress applied to the bent portion of the electrode during charging and discharging. However, the manufacturing process may be complicated and the electrodes may be pushed when an impact is applied, causing a short circuit.

A process of manufacturing an electrode assembly includes a process of stacking and aligning the anode plate, the separator, and the cathode plate. There are lead tabs on each of the anode plate and the cathode plate, and as the anode plate and the cathode plate are stacked, the lead tab of the anode plate and the lead tab of the cathode plate are aligned together. Accordingly, the lead tab of the anode plate and the lead tab of the cathode plate are maintained in the aligned and stacked state, but when impacts are applied to the electrode assembly, a problem may occur in which the aligned lead tabs become distorted.

### SUMMARY

According to an aspect of the present disclosure, the purpose is to effectively align stacked lead tabs.

According to an aspect of the present disclosure, lead tabs may be maintained in an aligned state.

In some embodiments of the present disclosure, a secondary battery cell comprises: a casing; and an electrode assembly accommodated in the casing and having electrode plates stacked with a separator interposed therebetween, wherein the electrode plate and the separator are adhered to each other by a coating layer, the electrode plate includes an electrode uncoated portion on which an active material is not applied to a portion of the electrode plate, and an electrode current collector to which an active material is applied, and the coating layer includes a first coating layer formed on the electrode uncoated portion.

In an embodiment, the first coating layer may be formed on both surfaces of the electrode uncoated portion.

In an embodiment, the coating layer may be formed by applying and drying a slurry.

In an embodiment, the slurry may include at least one of epoxy, polyimide (PI), and polyamide-imide (PAI).

In an embodiment, a melting point of the coating layer may be higher than a melting point of the separator.

In an embodiment, the electrode uncoated portion may include a first region facing the separator and a second region, not facing the separator, the first coating layer may be formed on at least a portion of the first region, and the second region may be connected to an electrode lead.

In an embodiment, the second region may include a lead tab connected to the electrode lead, and the coating layer may further include a second coating layer formed in a portion of the second region.

In an embodiment, the second coating layer may be formed on both surfaces of the second region.

In an embodiment, a thickness of the first coating layer and a thickness of the second coating layer may be different from each other.

In an embodiment, the first region may be disposed between the electrode current collector and the second region.

In an embodiment, the electrode plate may include a cathode plate and an anode plate, the electrode lead may include a cathode lead and an anode lead, an electrode uncoated portion of the cathode plate may be connected to the cathode lead, an electrode uncoated portion of the anode plate may be connected to the anode lead, and the cathode lead and the anode lead may be disposed on the electrode plate in the same direction.

In an embodiment, the electrode plate may include a cathode plate and an anode plate, the electrode lead may include a cathode lead and an anode lead, an electrode uncoated portion of the cathode plate may be connected to the cathode lead, an electrode uncoated portion of the anode plate may be connected to the anode lead, and the anode lead and the cathode lead may be disposed on the electrode plate in opposite directions.

According to an embodiment of the present disclosure, a secondary battery cell in which stacked lead tabs are effectively aligned may be provided.

According to an embodiment of the present disclosure, a secondary battery cell in which lead tabs may be maintained in an aligned state may be provided.

### BRIEF DESCRIPTION OF DRAWINGS

Certain aspects, features, and advantages of the present disclosure are illustrated by the following detailed description with reference to the accompanying drawings.

FIG. 1 is an exploded perspective view of a portion of an electrode assembly;

FIG. 2 is a front view illustrating an electrode plate, an electrode lead, and a separator in which a second coated layer is not formed.

FIG. 3 is a front view illustrating an electrode uncoated portion, a separator, and an electrode lead in which a second coating layer is additionally formed;

FIG. 4 is an exploded perspective view of a battery cell including an electrode uncoated portion in which a second coating layer is additionally formed;

FIG. 5 is a side view illustrating a state in which an electrode assembly according to an embodiment of the present disclosure is stacked; and

FIG. 6A is a perspective view of a battery cell according to an embodiment of the present disclosure, and FIG. 6B is a perspective view of a battery cell according to another embodiment of the present disclosure.

### DETAILED DESCRIPTION

Prior to describing the exemplary embodiments in detail, it should be understood that the terms used in the specification and the appended claims should not be construed as being limited to general and dictionary meanings, but interpreted based on the meanings and concepts corresponding to technical aspects of the present disclosure on the basis of the principle that the inventor is allowed to define terms appropriately for the best explanation. Therefore, it should be understood that the embodiments described in this specification and the configurations illustrated in the drawings are only the most desirable embodiments of the present disclosure and do not represent all the technical concepts of the present disclosure, and accordingly, there may be various equivalents and variations that can replace the embodiments and the configurations of the present disclosure at the time of this application.

Hereinafter, with reference to the drawings, specific embodiments of the present disclosure will be described. In this case, it should be noted that in the attached drawings, identical components are indicated by identical symbols whenever possible. Additionally, detailed descriptions of well-known functions and configurations that may obscure the gist of the present disclosure will be omitted. For the same reason, some components are exaggerated, omitted, or schematically depicted in the accompanying drawings, and the size of each component does not entirely reflect its actual size.

An embodiment of the present disclosure relates to a secondary battery, and hereinafter, the secondary battery according to the present disclosure will be described in detail with reference to the drawings.

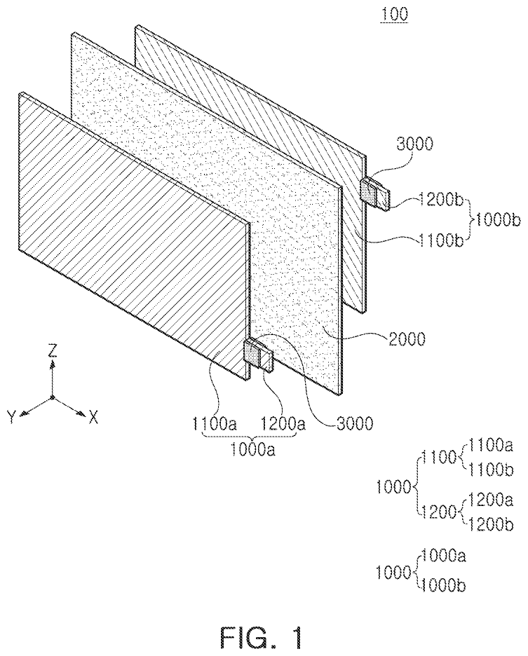

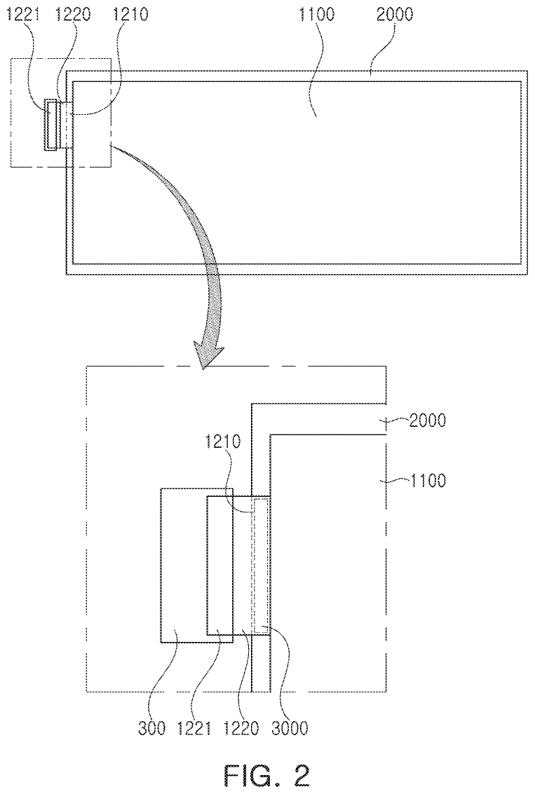

First, an electrode assembly 100 will be described with reference to FIGS. 1 and 2.

FIG. 1 is an exploded perspective view of a portion of the electrode assembly 100.

The electrode assembly 100 may include a plurality of electrode plates 1000 and a separator 2000. The electrode plate 1000 may include an electrode current collector 1100 to which an electrode active material is applied, and an electrode uncoated portion 1200 to which the electrode active material is not applied.

The electrode plate 1000 may include a cathode plate 1000a and an anode plate 1000b, and the cathode plate 1000a and the anode plate 1000b may be determined depending on the polarity of the electrode current collector 1100. The electrode current collector 1100 may include a cathode current collector 1100a and an anode current collector 1100b, and the polarity of the electrode current collector 1100 is determined depending on the type of electrode active material applied. For example, the cathode current collector 1100a may be manufactured by applying a slurry of a cathode active material, a conductive material, and a binder to the electrode plate 1000, and then drying and pressing the slurry. In this case, the slurry may further include a filler as needed. The anode current collector 1100b may be manufactured differently by applying an anode active material.

The electrode uncoated portion 1200 may be not coated with an electrode active material, and may be provided in the same manner in the cathode plate 1000a and the anode plate 1000b. However, for convenience of explanation, hereinafter, the electrode uncoated portion 1200 of the cathode plate 1000a will be referred to as a cathode uncoated portion 1200a, and the electrode uncoated portion 1200 of the anode plate 1000b will be referred to as an anode uncoated portion 1200b.

The electrode current collector 1100 is generally manufactured with a thickness of 3 to 500 μm. The electrode current collector 1100 is usually formed of a material that does not cause chemical changes and has high conductivity. The most representative materials are stainless steel, aluminum, nickel, titanium, and sintered carbon, but a surface of aluminum or stainless steel is surface-treated with carbon, nickel, titanium, silver, or the like. However, the present disclosure is not limited thereto. Additionally, the cathode current collector 1100a may form fine irregularities on the surface to increase the adhesive force of the cathode active material.

For example, when the cathode active material is a lithium secondary battery, the cathode active material may be layered compounds such as lithium cobalt oxide (LiCoO₂) and lithium nickel oxide (LiNiO₂) or compounds substituted with one or more transition metals; lithium manganese oxide with Formula Li₁₊ₓMn₂₋ₓO₄ (x is 0 to 0.33), LiMnO₃, LiMn₂O₃, LiMnO₂ or the like; lithium copper oxide (Li₂CuO₂); vanadium oxide such as LiV₃O₈, Life₃O₄, V₂O₅, Cu₂V₂O₇, or the like; Ni site-type lithium nickel oxide represented by Formula LiNi₁₋ₓ MₓO₂ (M═Co, Mn, Al, Cu, Fe, Mg, B or Ga, x=0.01 to 0.3); lithium manganese composite oxide represented by Formula LiMn₂₋ₓMₓO₂ (M═Co, Ni, Fe, Cr, Zn or Ta, x=0.01 to 0.1) or Li₂Mn₃MO₈ (M=Fe, Co, Ni, Cu or Zn); LiMn₂O₄ in which a portion of Li in a chemical formula is replaced with an alkaline earth metal ion; disulfide compounds; and Fe₂(MOO₄)₃. However, the present disclosure is not limited thereto.

The anode active material may be, for example, carbon such as non-graphitized carbon and graphitic carbon; metal complex oxides such as LiₓFe₂O₃ (0=x=1), LixWO₂ (0=x=1), and SnₓMe₁₋ₓMe′yOz (Me: Mn, Fe, Pb, Ge; Me′: Al, B, P, Si, Group 1, Group 2 and 3 elements of the periodic table, halogen; 0<x=1; 1=y=3; 1=z=8); a lithium metal; a lithium alloy; a silicon-based alloy; tin-based alloy; metal oxides such as Sno, SnO₂, Pbo, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; a conductive polymer such as polyacetylene; and a Li—Co—Ni based material.

The separator 2000 may include a porous polymer substrate and a porous coating layer, and may maintain an insulating state and ensure the stability of the electrode assembly 100. As the porous polymer substrate, a porous polymer film or a porous polymer nonwoven fabric substrate formed of various polymers may be used. The porous coating layer may be formed on one surface of the porous polymer substrate, and may be coated with a slurry including a mixture of inorganic particles and a polymer binder.

In the electrode assembly 100, the electrode plates 1000 may be stacked so that the electrode current collectors 1100 face each other, and the cathode plate 1000a and the anode plate 1000b may be alternately stacked as the electrode plates 1000. For example, the anode plate 1000b, the separator 2000, the cathode plate 1000a, and the separator 2000 may be repeatedly stacked in that order, but the present disclosure is not limited thereto. For example, the cathode plate 1000a, the separator 2000, and the cathode plate 1000a may be stacked in that order, and a manner in which the electrode plate 1000 is stacked may be variously changed. However, even when electrode plates 1000 having different polarities are disposed, the electrode current collectors 1100 may be disposed so as to overlap each other.

The electrode uncoated portion 1200 is an electrode plate 1000 on which no electrode active material is applied, and may be provided to protrude from the electrode current collector 1100 in one direction. Referring to FIG. 1, the cathode uncoated portion 1200a and the anode uncoated portion 1200b may be provided in the same direction. For example, the cathode uncoated portion 1200a and the anode uncoated portion 1200b may protrude in a +X-direction. However, a position in which the cathode uncoated portion 1200a protrudes and a position in which the anode uncoated portion 1200b protrudes may be different from each other. For example, the cathode uncoated portion 1200a and the anode uncoated portion 1200b may be disposed to be spaced apart from each other in a Z-direction. Accordingly, the cathode uncoated portion 1200a and the anode uncoated portion 1200b may be stacked in different positions. FIG. 1 illustrates an electrode assembly 100 in which the cathode uncoated portion 1200a and the anode uncoated portion 1200b are provided in the same direction, but the present disclosure is not limited thereto, and the cathode uncoated portion 1200a and the anode uncoated portion 1200b may be provided in opposite directions. For example, the cathode uncoated portion 1200a may protrude in the +X-direction, and the anode uncoated portion 1200b may protrude in the −X-direction.

FIG. 2 is a front view illustrating an electrode plate, an electrode lead, and a separator in which a second coating layer is not formed.

Referring to FIGS. 1 and 2, the separator 2000 and the electrode current collector 1100 may be disposed to face each other. A cross-sectional area of the electrode current collector 1100 may be smaller than a cross-sectional area of the separator 2000. Accordingly, the separator 2000 may be arranged to cover the electrode current collector 1100.

The electrode uncoated portion 1200 may be provided in a protruding form from the electrode current collector 1100, and the electrode uncoated portion 1200 may include a first region 1210 facing the separator 2000 and a second region 1220, not facing the separator 2000. Additionally, a coating layer 3000 may be formed on at least a portion of the first region 1210 of the electrode uncoated portion 1200, and the second region 1220 may be connected to an electrode lead 300. For example, the second region 1220 may include a lead tab 1221 connected to the electrode lead 300.

A plurality of electrode plates 1000 may be stacked with a separator 2000 interposed therebetween. The electrode plate 1000 may include a cathode plate 1000a and an anode plate 1000b, and the electrode lead 300 may include a cathode lead 300a connected to the cathode uncoated portion 1200a and an anode lead 300b connected to the anode uncoated portion 1200b. Since the cathode uncoated portion 1200a and the anode uncoated portion 1200b may be stacked in different positions, the cathode lead 300a and the anode lead 300b may be arranged in different positions.

The electrode uncoated portions 1200 of the electrode plate 1000 having the same polarity may be welded to be connected to the electrode lead 300. Accordingly, the cathode uncoated portions 1200a may be stacked and welded to be connected to the cathode lead 300a, and the anode uncoated portions 1200b may be stacked and welded to be connected to the anode lead 300b.

In the prior art, in the process of stacking the electrode plate 1000 and the separator 2000, there were many cases in which an alignment of the electrode uncoated portion 1200 connected to the electrode lead 300 was misaligned or the electrode was detached. Accordingly, the number of electrode plates 1000 connected to the cathode lead 300a and the number of electrode plates 1000 connected to the anode lead 300b may vary, and problems with capacitance deterioration may occur.

In an embodiment of the present disclosure, since the coating layer 3000 may be formed on the electrode uncoated portion 1200, the electrode plate 1000 and the separator 2000 may be adhered to each other by the coating layer 3000.

The coating layer 3000 must be able to maintain adhesiveness and maintain the electrode plate 1000 and the separator 2000 in an adhered state. For example, the coating layer 3000 must maintain adhesiveness even as the temperature increases and be able to resist shrinkage of the separator 2000.

The coating layer 3000 may be formed by applying a slurry to the electrode uncoated portion 1200 and drying the slurry. As an example, the slurry may be manufactured by utilizing N-methyl-2-pyrroldidone (NMP) as a solvent, and mixing epoxy, Polyimide (PI), and Polyamide-imide (PAI). The heat resistance properties of the slurry may be adjusted depending on the content of PI and PAI, and a glass transition temperature of the slurry may be 275° C. or higher. A melting point of the coating layer 3000 may be made high by corresponding to the heat resistance characteristics of the slurry, and the corresponding temperature may be higher than a melting point of the separator 2000. Accordingly, the coating layer 3000 may have superior heat resistance performance compared to the separator 2000, and may maintain adhesiveness stably. However, the coating layer 3000 is not limited to that formed by drying the above-described slurry. For example, any material that is thermally or chemically stable and has adhesive properties may be used as the coating layer 3000.

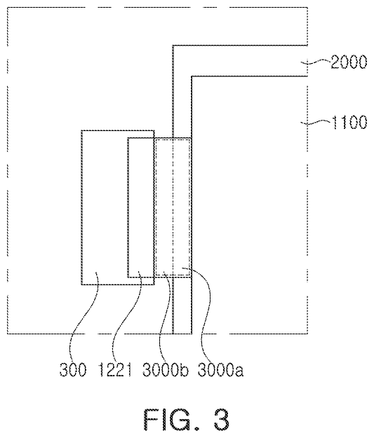

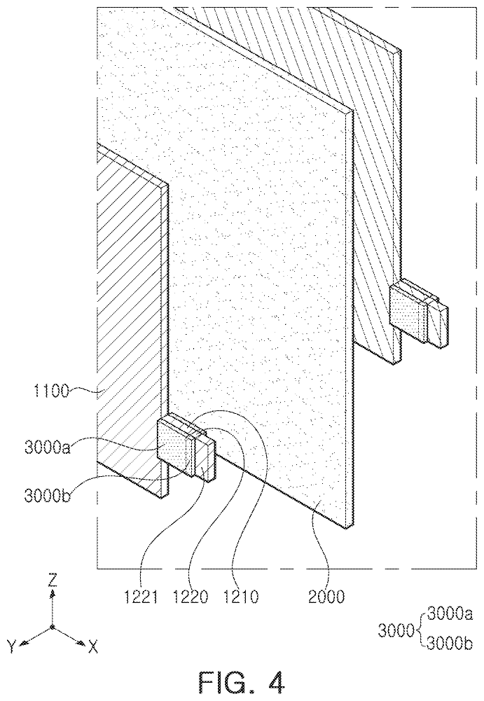

FIG. 3 is a front view illustrating an electrode uncoated portion, a separator, and an electrode lead on which a second coating layer is additionally formed, and FIG. 4 is an exploded perspective view of a battery cell including an electrode uncoated portion on which a second coating layer is additionally formed.

Referring to FIGS. 3 and 4, the electrode uncoated portion 1200 may include a first region 1210 facing the separator 2000 and a second region 1220, not facing the separator 2000. For example, the first region 1210 may be disposed between the electrode current collector 1100 and the second region 1220.

The coating layer 3000 may be formed in the first region 1210 and the second region 1220 of the electrode uncoated portion 1200. The coating layer 3000 may include a first coating layer 3000a formed on the electrode uncoated portion 1200. For example, the coating layer 3000 may include a first coating layer 3000a formed on at least a portion of the first region 1210 and a second coating layer 3000b formed on at least a portion of the second region 1220. Accordingly, the coating layer 3000 may be formed on one end of the separator 2000 that does not face the electrode current collector 1100, or may be formed in a position that does not face the separator 2000.

When the coating layer 3000 is not formed on the electrode uncoated portion 1200 but is provided on the lead tab 1221 to which the separator 2000 or the electrode lead 300 is connected, several problems may arise. For example, when forming the coating layer 3000 on the separator 2000, the coating layer 3000 may be formed by applying a high-temperature slurry to the separator 2000 and drying the applied slurry. The separator 2000 may include a porous polymer film, and when the high-temperature slurry is applied to the separator 2000 or an adhesive layer is formed on the separator 2000 for a long period of time, the porous polymer film may become clogged, which may cause the lifespan of the separator 2000 to deteriorate. As another example, when the coating layer 3000 is formed on the lead tab 1221 to which the electrode lead 300 is connected, in a process of welding or connecting the lead tab 1221 and the electrode lead 300, problems with poor welding or poor connection may occur due to the coating layer 3000.

According to an embodiment of the present disclosure, the coating layer 3000 may be formed in the first region 1210 of the electrode uncoated portion 1200 and the second region 1220 other than the lead tab 1221, and the problems described above may not occur.

According to FIG. 4, the electrode assembly of an embodiment of the present disclosure may be formed with a separator interposed between electrode plates having the same polarity.

Referring to FIG. 4, a coating layer 3000 may be formed on both surfaces of the electrode uncoated portion 1200. The coating layer 3000 may include a first coating layer 3000a and a second coating layer 3000b. As an example, a first coating layer 3000a may be formed in at least a portion of the first region 1210, and the first coating layer 3000a may be formed on both surfaces of the first region 1210. A second coating layer 3000b may be formed in at least a portion of the second region 1220 in addition to the first region 1210, and the second coating layer 3000b may be formed on both surfaces of the second region 1220.

The first coating layer 3000a formed in the first region 1210 may adhere the electrode uncoated portion 1200 and the separator 2000. The cathode plates 1000a may be stacked by overlapping electrode uncoated portions 1200, and the cathode uncoated portion 1200a may be fixed by adhering to the separator 2000. Accordingly, the lead tabs 1221 of the cathode plates 1000a may be fixed and aligned, and the aligned lead tabs 1221 may be connected to the cathode lead 300a.

Similarly, the anode plates 1000b may be stacked so that the electrode uncoated portions 1200 are disposed in the same location, and the anode uncoated portion 1200b may be fixed by adhering to the separator 2000. Accordingly, the lead tabs 1221 of the anode plates 1000b may be fixed and aligned, and the aligned lead tabs 1221 may be connected to the anode lead 300b.

A second coating layer 3000b may be additionally formed in at least a portion of the second region 1220. Since the second region 1220 does not face the separator 2000, the second coating layer 3000b does not come into contact with the separator 2000. According to an embodiment of the present disclosure, since the electrode uncoated portions 1200 of the electrode plate 1000 having the same polarity may overlap each other and be stacked, the contacting electrode uncoated portions 1200 may be adhered to each other by the second coating layer 3000b. Accordingly, the electrode uncoated portions 1200 may be additionally adhered by the second coating layer 3000b, the electrode uncoated portions 1200 may be aligned by adhering to each other. Accordingly, as the electrode uncoated portions 1200 are aligned, the aligned lead tabs 1221 may be connected to the electrode lead 300.

The lead tab 1221 may be connected to the electrode lead 300 through welding and may be provided in an end of the electrode uncoated portion 1200. A coating layer 3000 may be formed entirely on the electrode uncoated portion 1200 excluding the lead tab 1221. The coating layer 3000 formed on the electrode uncoated portion 1200 may be adhered to the separator 2000 or the electrode uncoated portion 1200 for alignment of the lead tab 1221.

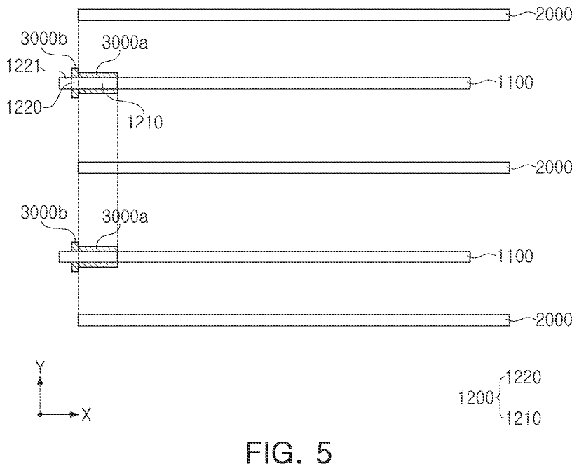

FIG. 5 is a side view illustrating a state in which an electrode assembly according to an embodiment of the present disclosure is stacked.

As illustrated in FIG. 5, an electrode assembly 100 may be manufactured by interposing the separator 2000 between the electrode plates 1000 and laminating the same. For example, the electrode assembly 100 may be formed by interposing the separator 2000 between the cathode plate 1000a including the cathode current collector 1100a and the cathode plate 1000a including the cathode current collector 1100a.

The coating layer 3000 may be formed on the electrode uncoated portion 1200 of the electrode plate 1000. Specifically, the coating layer 3000 may be formed on a portion of the first region 1210 and the second region 1220 of the electrode uncoated portion 1200 that is not the lead tab 1221.

Since the first region 1210 faces the separator 2000, the first coating layer 3000a formed in the first region 1210 may come into contact with the separator 2000. Accordingly, the first coating layer 3000a formed in the first region 1210 may enable the separator 2000 and the electrode plate 1000 to be adhered to each other.

The second region 1220 is a region that does not face the separator 2000, and the second regions 1220 may face each other. For example, the second region 1220 of the anode uncoated portion 1200b may face the second region 1220 of the anode uncoated portion 1200b, and the second region 1220 of the cathode uncoated portion 1200a may face the second region 1220 of the cathode uncoated portion 1200a. Since the separator 2000 is interposed between the electrode plates 1000, the second coating layer 3000b formed in the second region 1220 may be formed to have a certain thickness in order to come into contact with the second coating layer 3000b in the opposing second region 1220. That is, the second coating layer 3000b formed in the second region 1220 may be formed to have a different thickness from the first coating layer 3000a formed in the first region 1210. In other words, a thickness of the first coating layer 3000a and a thickness of the second coating layer 3000b are different from each other.

Referring to FIG. 5, the first coating layer 3000a and the second coating layer 3000b may be formed to have a thickness in the Y-direction, and a thickness of the second coating layer 3000b formed in the second region 1220 may be greater than a thickness of the first coating layer 3000a formed in the first region 1210.

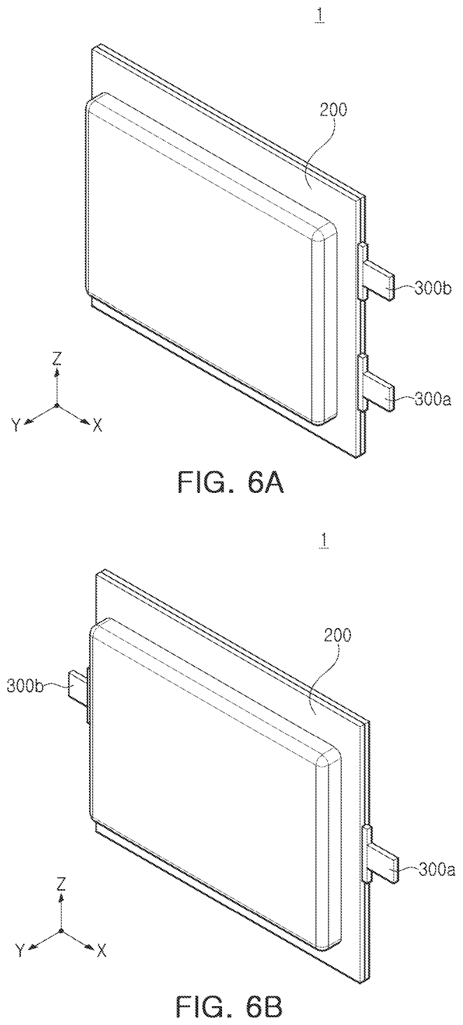

FIG. 6A is a perspective view of a battery cell according to an embodiment of the present disclosure, and FIG. 6B is a perspective view of a battery cell according to another embodiment of the present disclosure.

Referring to FIGS. 6A and 6B, a battery cell 1 according to an embodiment of the present disclosure may include an electrode assembly 100 and a casing 200. The electrode assembly 100 may be accommodated in the casing 200, and the electrode uncoated portion 1200 of the electrode plate 1000 may be connected to the electrode lead 300 disposed outside the casing 200. For example, the cathode uncoated portion 1200a of the cathode plate 1000a may be connected to the cathode lead 300a, and the anode uncoated portion 1200b of the anode plate 1000b may be connected to the anode lead 300b.

The casing 200 may accommodate the electrode assembly 100 through a pouch-shaped member as illustrated in FIGS. 6A and 6B, but the present disclosure is not limited thereto. For example, the casing 200 may be a prismatic member, and the battery cell 1 has a shape in which the electrode assembly 100 is accommodated in a prismatic member, and may be a prismatic battery cell.

The cathode lead 300a and the anode lead 300b may be disposed and fixed outside the casing 200. Referring to FIG. 6A, the cathode lead 300a and the anode lead 300b may be disposed on the electrode plate 1000 in the same direction. For example, both the cathode lead 300a and the anode lead 300b may be disposed in the +X-direction on the electrode plate 1000. However, the cathode lead 300a and the anode lead 300b may be disposed to be spaced apart from each other in the Z-direction and positions thereof may be different from each other.

Referring to FIG. 6B, the cathode lead 300a and the anode lead 300b may be disposed on the electrode plate 1000 in opposite directions. For example, the cathode lead 300a and the electrode plate 1000 may be disposed toward the +X-direction, but the anode lead 300b may be disposed on the electrode plate 1000 in the −X-direction. Accordingly, the cathode lead 300a and the anode lead 300b may be disposed in different positions.

Although various embodiments of the present disclosure have been described in detail above, the scope of the present disclosure is not limited thereto, and it will be apparent to those skilled in the art that modifications and variations could be made without departing from the scope of the present disclosure as defined by the appended claims. In addition, some components may be deleted and implemented in the above-described example embodiments, and each of the embodiments may be combined and implemented with each other.

What is claimed is:

1. A secondary battery cell, comprising:
a casing; and
an electrode assembly accommodated in the casing and having electrode plates stacked with a separator interposed therebetween,
wherein the electrode plate and the separator are adhered to each other by a coating layer,
the electrode plate includes an electrode uncoated portion on which an active material is not applied to a portion of the electrode plate, and an electrode current collector to which an active material is applied, and
the coating layer includes a first coating layer formed on the electrode uncoated portion.

2. The secondary battery cell of claim 1, wherein the first coating layer is formed on both surfaces of the electrode uncoated portion.

3. The secondary battery cell of claim 1, wherein the coating layer is formed by applying and drying a slurry.

4. The secondary battery cell of claim 3, wherein the slurry includes at least one of epoxy, polyimide (PI), and polyamide-imide (PAI).

5. The secondary battery cell of claim 3, wherein a melting point of the coating layer is higher than a melting point of the separator.

6. The secondary battery cell of claim 1, wherein the electrode uncoated portion includes a first region facing the separator and a second region, not facing the separator,
the first coating layer is formed on at least a portion of the first region, and
the second region is connected to an electrode lead.

7. The secondary battery cell of claim 6, wherein the second region includes a lead tab connected to the electrode lead, and
the coating layer further includes a second coating layer formed in a portion of the second region.

8. The secondary battery cell of claim 7, wherein the second coating layer is formed on both surfaces of the second region.

9. The secondary battery cell of claim 7, wherein a thickness of the first coating layer and a thickness of the second coating layer are different from each other.

10. The secondary battery cell of claim 6, wherein the first region is disposed between the electrode current collector and the second region.

11. The secondary battery cell of claim 6, wherein the electrode plate includes a cathode plate and an anode plate,
the electrode lead includes a cathode lead and an anode lead,
an electrode uncoated portion of the cathode plate is connected to the cathode lead,
an electrode uncoated portion of the anode plate is connected to the anode lead, and
the cathode lead and the anode lead are disposed on the electrode plate in the same direction.

12. The secondary battery cell of claim 6, wherein the electrode plate includes a cathode plate and an anode plate,
the electrode lead includes a cathode lead and an anode lead,
an electrode uncoated portion of the cathode plate is connected to the cathode lead,
an electrode uncoated portion of the anode plate is connected to the anode lead, and
the anode lead and the cathode lead are disposed on the electrode plate in opposite directions.
